(19) United States
(12) Patent Application Publication
(10) Pub. No.: US 2026/0288393 A1
(43) Pub. Date: Sep. 24, 2026

(54) INFORMATION PROCESSING APPARATUS, INFORMATION PROCESSING SYSTEM, CONTROL METHOD OF INFORMATION PROCESSING APPARATUS, AND STORAGE MEDIUM

(71) Applicant: CANON KABUSHIKI KAISHA, Tokyo (JP)

(72) Inventor: Yuuichi Nitto, Kanagawa (JP)

(21) Appl. No.: 19/563,064

(22) Filed: Mar. 11, 2026

(30) Foreign Application Priority Data
Mar. 19, 2025 (JP) 2025-045620

(51) Int. Cl. G06F 3/12

(52) U.S. Cl. CPC G06F 3/1247; G06F 3/1206; G06F 3/1287

(57) ABSTRACT

An information processing apparatus configured to cooperate with a server that provides a cloud print service, the information processing apparatus comprising one or more memory devices that store a set of instructions; and one or more processors that execute the set of instructions to: output a predetermined form for a print job that streamlines a communication amount or a storage amount to another information processing apparatus that generates the print job; obtain the print job in the predetermined form from the other information processing apparatus; determine a conversion method for converting the predetermined form of the obtained print job into a form processable by an image forming apparatus; and convert a form of the print job using the conversion method.

### BACKGROUND

### Field of the Technology

The present disclosure relates to an information processing apparatus, an information processing system, a control method of the information processing apparatus, and a storage medium.

### Description of the Related Art

It is desirable to efficiently transmit print data to a printing apparatus from an information processing apparatus that generates print jobs. Japanese Patent No. 6981207 realizes efficient transmission by compressing print data and transmitting the print data in compressed form to the printing apparatus.

With the above-mentioned conventional technology, corresponding processing for decompressing the print data in compressed form is required in the printing apparatus. That is, if the printing apparatus does not support processing of print data in compressed form, the print data is transmitted in uncompressed form. In such cases, the size of print jobs increases, and communication efficiency, storage efficiency and the like of print jobs decrease as a result. In particular, in the case of a cloud printing system mediated by a print server, whether or not the printing apparatus supports such processing for handling compressed data will affect the communication efficiency of the entire system.

### SUMMARY

The present disclosure enables realization of streamlining of the communication amount or storage amount of print jobs in a cloud printing system, in the case where an image forming apparatus does not support a print job form for realizing such streamlining.

One aspect of the present disclosure provides an information processing apparatus configured to cooperate with a server that provides a cloud print service, the information processing apparatus comprising one or more memory devices that store a set of instructions; and one or more processors that execute the set of instructions to: output a predetermined form for a print job that streamlines a communication amount or a storage amount to another information processing apparatus that generates the print job; obtain the print job in the predetermined form from the other information processing apparatus; determine a conversion method for converting the predetermined form of the obtained print job into a form processable by an image forming apparatus; and convert a form of the print job using the conversion method.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an information processing system according to one embodiment.

FIGS. 2A and 2B are hardware configuration diagrams of respective apparatuses according to one embodiment.

FIG. 3 is a functional block diagram of an information processing system according to one embodiment.

FIG. 4 is a flowchart of processing according to one embodiment.

FIGS. 5A, 5B and 5C are diagrams showing table information according to one embodiment.

FIG. 6 is a flowchart of processing according to one embodiment.

FIG. 7 is a flowchart of processing according to one embodiment.

FIGS. 8A and 8B are diagrams showing table information according to one embodiment.

FIG. 9 is a schematic diagram of an information processing system according to one embodiment.

FIG. 10 is a functional block diagram of an information processing system according to one embodiment.

FIG. 11 is a flowchart of processing according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### System Configuration

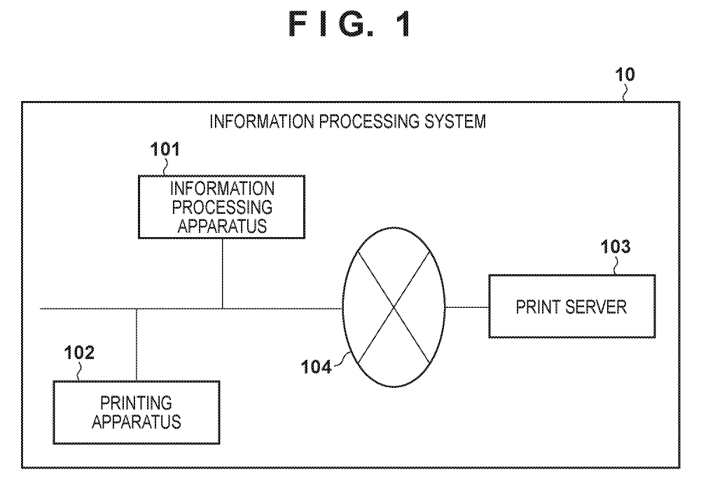

The configuration of an information processing system according to a first embodiment will be described using FIG. 1. An information processing system 10 includes an information processing apparatus 101 (example of “another information processing apparatus” and “third information processing apparatus”), a printing apparatus 102 (example of “image forming apparatus”), and a print server 103 (example of “information processing apparatus”). The information processing apparatus 101, the printing apparatus 102, and the print server 103 are connected to each other via a network 104. That is, these apparatuses are connected to each other in a manner that enables two-way communication by a communication network such as the Internet or a mobile phone network, a wireless LAN (Local Area Network), short-range wireless communication or the like or by a known communication technology. The information processing apparatus 101 is capable of communicating with the print server 103 via the network 104. The printing apparatus 102 is capable of communicating with the print server 103 via the network 104.

The printing apparatus 102 has a printing function for performing printing using print jobs. The printing apparatus 102 may include at least one of a scanner function and a fax function, apart from the printing function. Such printing apparatuses having multiple functions are also called MFPs (Multi-Function Printers). Alternatively, the printing apparatus 102 may be a dedicated device having only a printing function (SFP: Single-Function Printer). Printing may be printing on a sheet-like recording medium such as paper or may be formation of a three-dimensional object (so-called 3D printing).

The print server 103 provides a print service for transmitting print jobs to the printing apparatus 102, in accordance with print jobs generated by the information processing apparatus 101. For example, the print server 103 provides a logical printer to the information processing apparatus 101 and receives print jobs for the logical printer. A logical printer is a virtual printing apparatus (e.g., a printer object) provided by the print server 103. Logical printers are also called cloud printers. Note that, in contrast to logical printers, physical printing apparatuses such as the printing apparatus 102 can also be called physical printers. In the following description, logical printers and physical printers are collectively referred to simply as printers. A physical printer is also called a local printer, in the case of being connected to the same LAN as the information processing apparatus that inputs the print job.

The print server 103 may be a server within an on-premises environment connected to a wide area network, or may be a server within a cloud computing environment (hereinafter, simply “cloud”). The print service provided by the print server 103 within the cloud is also called a cloud print service (hereinafter, “CPS”). One example of a cloud print service is Microsoft’s Universal Print (registered trademark). That is, the print server 103 may provide a cloud print service in cooperation with a server that provides the Universal Print service. The following describes the case where the print server 103 is within a cloud. Note that the following description similarly applies to the case where the print server 103 is located within an on-premises environment.

The information processing apparatus 101 provides a printing function to a user of the information processing apparatus 101. The information processing apparatus 101 may be a personal computer (PC), or may be a smartphone or other device. The information processing apparatus 101 may, for example, designate the logical printer provided by the print server 103 as an output destination. When the logical printer is designated as the output destination, a physical printer (e.g., printing apparatus 102) associated with the logical printer performs the printing. The information processing apparatus 101 that utilizes the CPS is also called a client or a client terminal. Printing performed by inputting print jobs to the logical printer is also called cloud printing, remote print processing, or remote printing. Printing by cloud printing may be executed by the printing apparatus 102 connected to the same LAN as the information processing apparatus 101, or by a printing apparatus not connected to the same LAN.

The information processing apparatus 101 may have a printing function that is included as standard in an operating system (OS). Such a printing function is called a standard printing function. The standard printing function can also be called an OS standard printing function or a native printing function. In the case of having the standard printing function, the information processing apparatus 101 does not require separate software (e.g., driver), in order to use a printing apparatus that supports the standard printing function. Examples of the standard printing function include AirPrint (registered trademark), which is included as standard in iOS, macOS (registered trademark) and the like, and Mopria (registered trademark), which is included as standard in Android and the like.

### Hardware Configurations

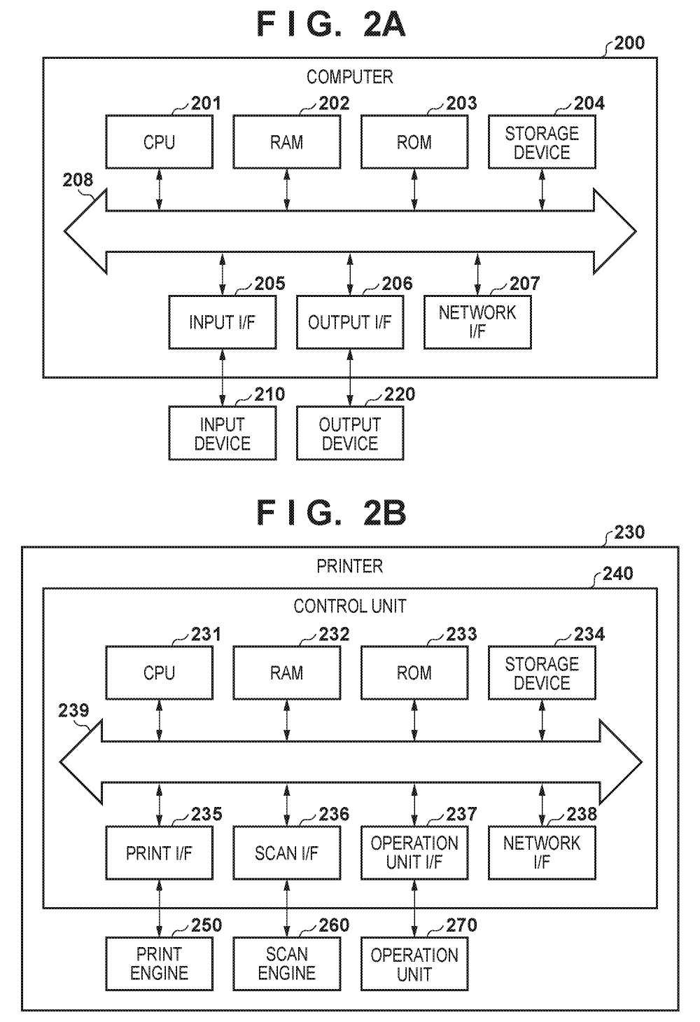

The hardware configurations of the respective apparatuses constituting the information processing system according to the first embodiment will be described using FIGS. 2A and 2B. FIG. 2A illustrates the hardware configuration of a computer 200 in the first embodiment. The computer 200 may, for example, be used as the information processing apparatus 101, or may be used as the print server 103. Note that, in the case where the computer 200 is used as the print server 103, a CPU 201 is an example of a “control unit”.

The computer 200 includes the central processing unit (CPU) 201, a random access memory (RAM) 202, a read-only memory (ROM) 203, and a storage device 204. Also, the computer 200 includes an input interface (I/F) 205, an output I/F 206, and a network I/F 207.

The CPU 201 is a general-purpose processing circuit that controls the overall operations of the computer 200. The RAM 202 is a volatile memory circuit and is used as a temporary storage area such as a work area for processing by the CPU 201. The ROM 203 is a non-volatile memory circuit and stores programs and data that are used in processing by the CPU 201. The storage device 204 is a non-volatile storage device and stores programs and data that are used in the processing by the CPU 201. The storage device 204 may be, for example, a hard disk drive (HDD) or a solid-state drive (SSD). The storage device 204 is also called a secondary storage device. Operations by the computer 200 may be realized by the CPU 201 executing programs read out from the storage device 204 to the RAM 202.

The input interface (I/F) 205 is an I/F for exchanging signals with an input device 210. The input device 210 is a device that obtains inputs from the user of the computer 200. The input device 210 may be, for example, a keyboard, a touch panel, a microphone, a mouse, or any combination thereof. The output I/F 206 is an I/F for exchanging signals with an output device 220. The output device 220 is a device that provides information to the user of the computer 200. The output device 220 may be, for example, a display, a speaker, or any combination thereof. The network I/F 207 is an I/F for communicating with apparatuses external to the computer 200 and includes a communication module.

The CPU 201, the RAM 202, the ROM 203, the storage device 204, the input I/F 205, the output I/F 206, and the network I/F 207 are each connected to a system bus 208. In the examples of FIGS. 2A and 2B, the input device 210 and the output device 220 are shown as separate devices from the computer 200. Alternatively, the computer 200 may include the input device 210 and the output device 220.

FIG. 2B illustrates the hardware configuration of a printer 230 in the first embodiment. The printer 230 may be used as the printing apparatus 102, for example. The printer 230 is a physical printing apparatus and is thus also called a physical printer.

The printer 230 includes a control unit 240, a print engine 250, a scan engine 260, and an operation unit 270. Furthermore, the control unit 240 includes a CPU 231, a RAM 232, a ROM 233, a storage device 234, a print I/F 235, a scan I/F 236, an operation unit I/F 237, and a network I/F 238.

The CPU 231 is a general-purpose processing circuit that controls the overall operations of the printer 230. The RAM 232 is a volatile memory circuit and is used as a temporary storage area such as a work area for processing by the CPU 231. The ROM 233 is a non-volatile memory circuit and stores programs and data that are used in processing by the CPU 231. The storage device 234 is a non-volatile storage device and stores programs and data (e.g., print jobs, image data, and setting information) that are used in processing by the CPU 231. The storage device 234 may be an HDD or an SSD, for example. The storage device 234 is also called a secondary storage device. Operations by the printer 230 may be realized by the CPU 231 executing programs read out from the storage device 234 to the RAM 232.

The print I/F 235 is an I/F for exchanging signals with the print engine 250. The print engine 250 performs printing using signals (e.g., image signals or print commands) supplied by the control unit 240 through the print I/F 235. Printing may be electrophotographic printing that involves toner being transferred to paper and fixed, inkjet printing that involves printing by discharging ink onto paper, or 3D printing.

The scan I/F 236 is an I/F for exchanging signals with the scan engine 260. The scan engine 260 supplies signals (e.g., image signals) obtained by scanning documents to the control unit 240 through the scan I/F 236. The CPU 231 may process the image signals supplied by the scan engine 260 and supply recorded image signals obtained thereby to the print engine 250. Also, the CPU 231 may generate image data using the image signals supplied by the scan engine 260 and transmit the generated image data to an external device.

The operation unit I/F 237 is an I/F for exchanging signals with the operation unit 270. The operation unit 270 is a device that obtains inputs from the user of the printer 230 and provides information to the user of the printer 230. The operation unit 270 may be constituted by, for example, a display panel (e.g., LCD display), a speaker, a touch panel, a keyboard, buttons, a touch screen, or any combination thereof. The network I/F 238 is an I/F for communicating with devices external to the printer 230 and includes a network module. Also, the constituent units included in the control unit 240 are each connected to a system bus 239.

### Functional Configuration

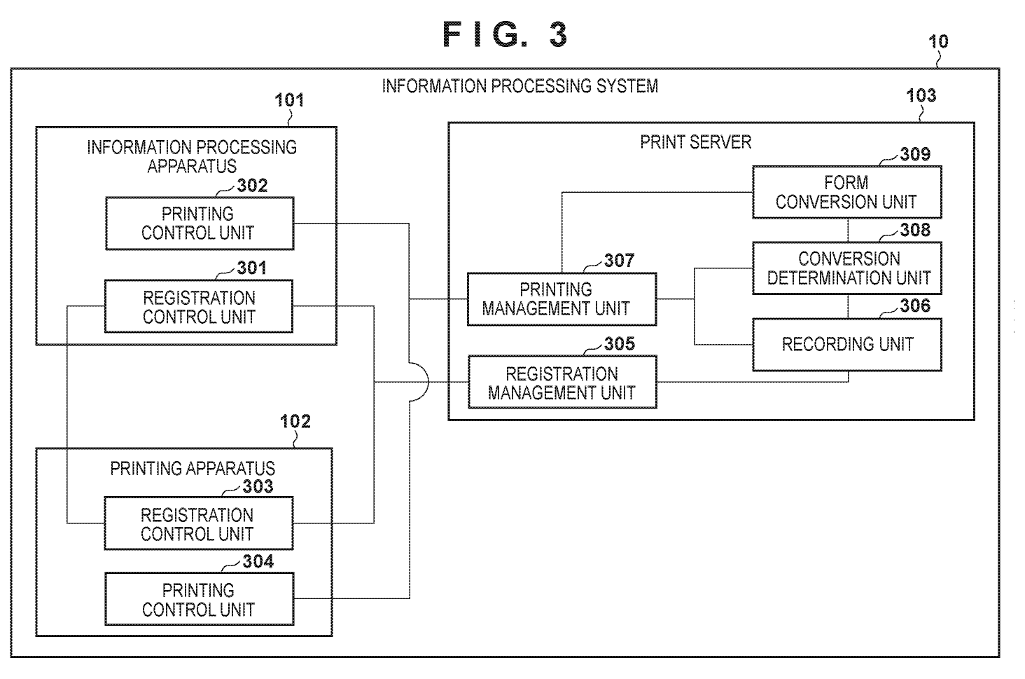

The functional blocks of the apparatuses constituting the information processing system 10 according to the first embodiment will now be described using FIG. 3. The functional units in FIG. 3 may be realized by the CPU 201 executing programs read out to the RAM 202 of the computer 200. Also, these functional blocks may be realized by the CPU 231 executing programs read out to the RAM 232 of the printer 230. Alternatively, some or all of the functional units in FIG. 3 may be realized by a dedicated processing circuit such as an application-specific integrated circuit (ASIC).

The information processing apparatus 101 includes a registration control unit 301 and a printing control unit 302. The registration control unit 301 performs processing for registering a logical printer in the print server 103. The printing control unit 302 performs processing related to printing by a printer. For example, the printing control unit 302 transmits print jobs to the logical printer registered in the print server 103, in accordance with printing instructions from the user of the information processing apparatus 101. The printing control unit 302 may transmit print jobs directly (i.e., within the same LAN) to a physical printer, in accordance with printing instructions from the user of the information processing apparatus 101.

The printing apparatus 102 includes a registration control unit 303 and a printing control unit 304. The registration control unit 303 performs processing for registering a logical printer associated with the printing apparatus 102 in the print server 103. The printing control unit 304 performs processing relating to printing. For example, the printing control unit 304 may execute printing in accordance with print jobs transmitted from the print server 103, by transferring print data included in the print jobs received from the print server 103 to the print engine 250. Also, the printing control unit 304 may transmit an event request to the print server 103.

The print server 103 includes a registration management unit 305, a recording unit 306, a printing management unit 307, a conversion determination unit 308, and a form conversion unit 309. The registration management unit 305 performs processing for registering a logical printer. For example, the registration management unit 305 generates a logical printer in association with a physical printer, in response to a registration request from the printing apparatus 102, and registers the generated logical printer in the recording unit 306 of the print server 103. The logical printer registered in the recording unit 306 is recognized as a printer by the information processing apparatus 101. The physical printer associated with the logical printer may be a physical printer that performs printing in accordance with print jobs input to the logical printer. The logical printer may be associated with only one physical printer. The physical printer may be associated with only one logical printer or may be associated with a plurality of logical printers.

The recording unit 306 performs processing such as storing information in the RAM 202 or the storage device 204 and reading out information from the RAM 202 or the storage device 204, in accordance with instructions from other functional units. The printing management unit 307 performs processing related to print jobs for the logical printer. For example, the printing management unit 307 receives print jobs for the logical printer from the information processing apparatus 101, and, based thereon, transmits the print jobs to a physical printer associated with the logical printer. Also, the printing management unit 307 may control events related to print jobs. Events related to print jobs may include, for example, receipt of print jobs. Also, the printing management unit 307 may return an event related to a physical printer, in response to receiving an event request from the physical printer.

The conversion determination unit 308 determines the conversion method of print jobs received from the information processing apparatus 101, when instructed by the printing management unit 307 of the print server 103. For example, assume that, with regard to the conversion determination unit 308, the form of the print job received from the information processing apparatus 101 does not match the form of print jobs processable by the physical printer associated with the designated logical printer. In this case, the conversion determination unit 308 determines to convert the print job to a form processable by the physical printer. The determined conversion method of the print job is recorded to the recording unit 306 of the print server 103 by the printing management unit 307.

The form conversion unit 309 converts the form of print jobs received from the information processing apparatus 101, when instructed by the printing management unit 307. For example, when a print job is in a compressed state, the form conversion unit 309 converts the print job to an uncompressed form by executing decompression processing. Note that the form of the print job may include, not only compressed/uncompressed but also the compressed file form (e.g., zip, gzip, etc.), or the job configuration (e.g., whether one print job includes a plurality of jobs, etc.). These forms are also examples of a “predetermined form”. The converted print job is sent to the printing apparatus 102 by the printing management unit 307 of the print server 103, for example, in order to be printed.

### Processing Flow

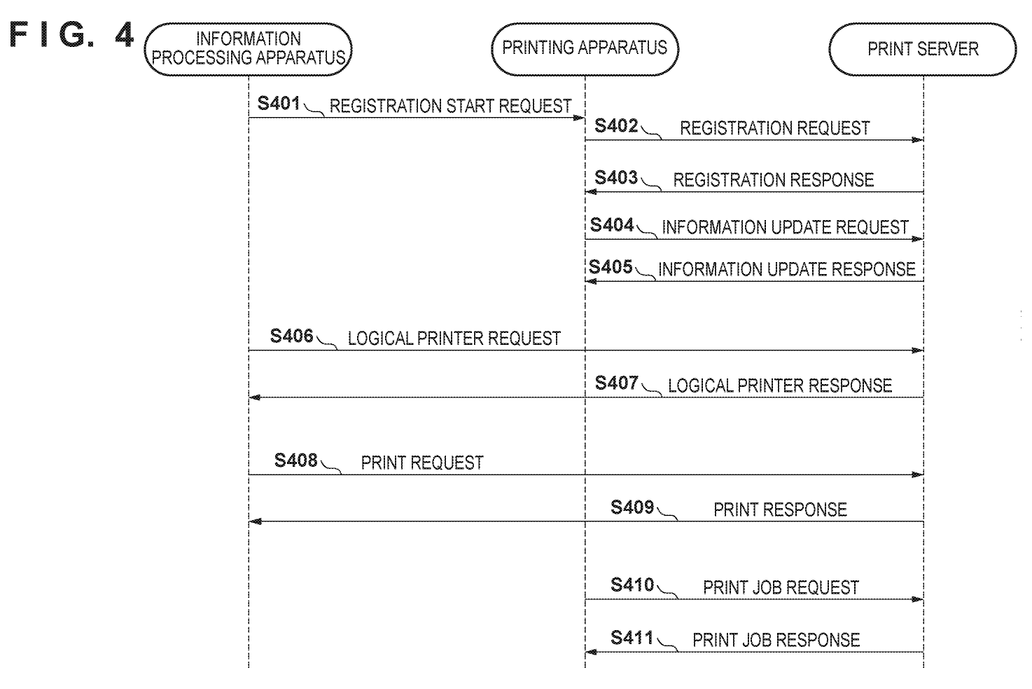

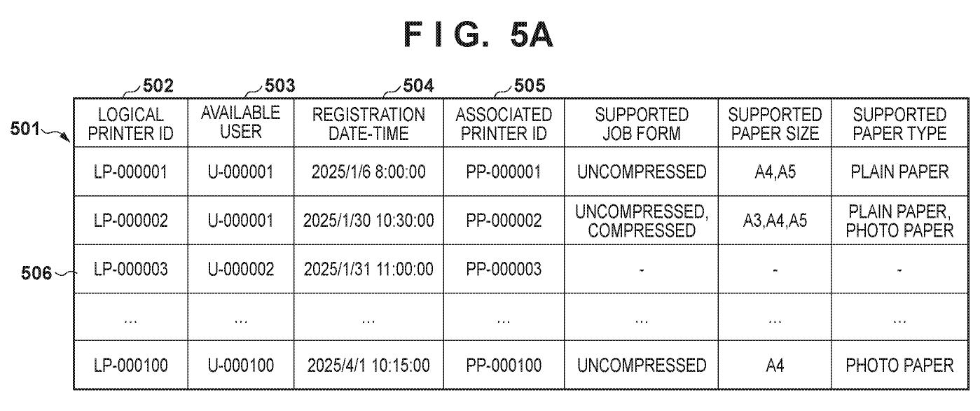

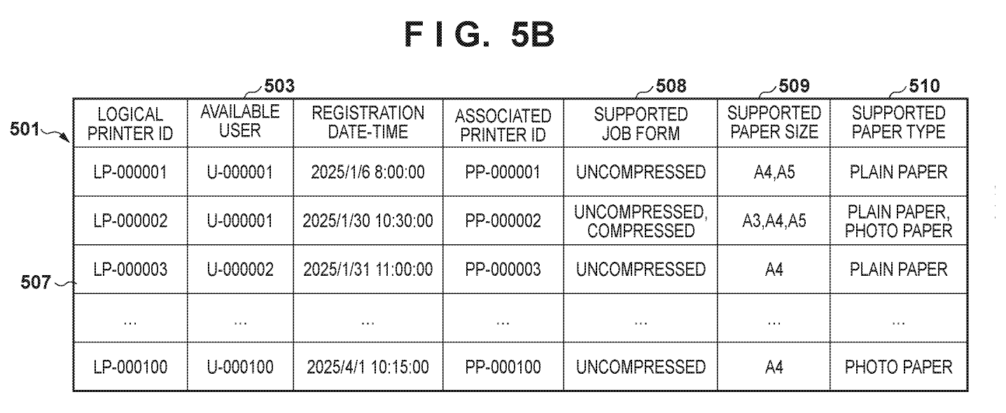

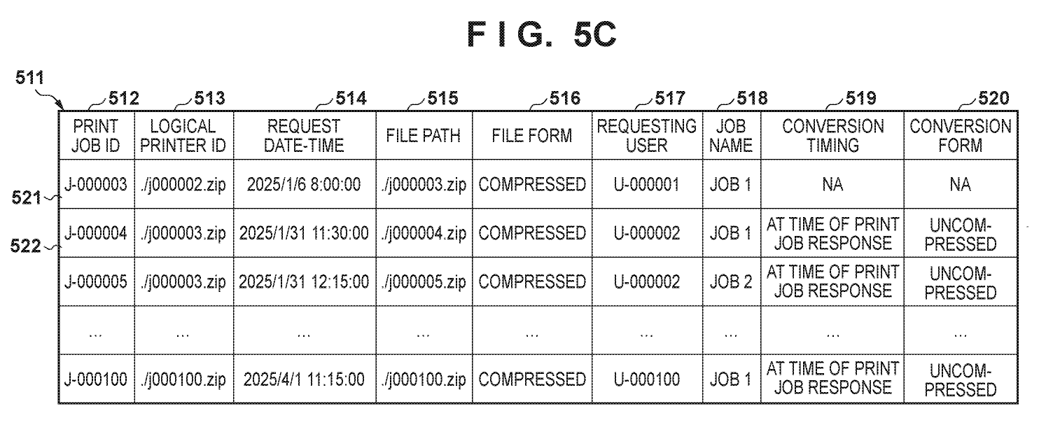

The flow of cloud print processing that is executed in the information processing system 10 according to the first embodiment will be described using FIG. 4 and FIGS. 5A to 5C. FIG. 4 illustrates a sequence flow in which the information processing apparatus 101 registers the printing apparatus 102 in the print server 103 and inputs print jobs to the logical printer associated with the printing apparatus 102. Note that this sequence flow is realized by, in each apparatus, the CPU loading a program stored in the ROM into the working area of the RAM and executing the loaded program, and the constituent units and the like being controlled through execution of the program.

Also, registering the printing apparatus 102 in the print server 103 involves registering the logical printer associated with the printing apparatus 102 in the print server 103. In the following example, it is assumed that the printing apparatus 102 supports a web user interface (UI) function for operating the printing apparatus 102 from the information processing apparatus 101. Also, it is assumed that the information processing apparatus 101 supports a web UI client function. Also, communication between the information processing apparatus 101, the printing apparatus 102 and the print server 103 may be performed using the Internet Printing Protocol (IPP) via the respective network I/Fs thereof.

In step S401, the registration control unit 301 of the information processing apparatus 101 transmits a registration start request to the printing apparatus 102, in accordance with an instruction from the user of the information processing apparatus 101. The registration start request is a request to start processing for registering the printing apparatus 102 in the print server 103. The registration start request may be transmitted using the web UI client function of the information processing apparatus 101. Also, the registration start request may include a user ID that uniquely represents the user who gave the instruction. The registration control unit 303 of the printing apparatus 102 then receives this registration start request.

In step S402, the registration control unit 303 of the printing apparatus 102 transmits a registration request to the print server 103, in response to receiving the registration start request from the information processing apparatus 101. The registration request is a request to register the printing apparatus 102 in the print server 103. Also, this registration request may include the user ID that is included in the received registration start request. The registration management unit 305 of the print server 103 then receives the registration request.

In step S403, the registration management unit 305 of the print server 103 generates a new logical printer, in response to receiving the registration request from the printing apparatus 102. Also, the registration management unit 305 instructs the recording unit 306 of the print server 103 to record the newly generated logical printer in association with the printing apparatus 102, that is, a physical printer.

The recording unit 306 records logical printer information such as is shown in FIG. 5A, for example, in a storage medium, in response to such an instruction. Logical printer information 501 in FIG. 5A illustrates part of the logical printer information recorded by the recording unit 306 of the print server 103. The records of the logical printer information 501 include logical printer information, printer information associated with the logical printer, and attribute information of the logical printer. For example, each record may include a uniquely identifiable logical printer ID 502 (example of “first identification information”), a user ID 503 that can uniquely identify a user who can use the logical printer, a registration date-time 504 and the like as information indicating the logical printer.

The information indicating the logical printer may be information obtained by referring to the received registration request from the printing apparatus 102, or may be information obtained directly from the information processing apparatus 101. Also, for example, a uniquely identifiable associated printer ID 505 may be stored as information indicating the associated printer. Such information indicating the associated printer may be information obtained by referring to the received registration request from the printing apparatus 102. By adopting the above configuration, the recording unit 306 records this obtained information in records 506 of the logical printer information 501.

Returning to the description of the sequence flow in FIG. 4, the registration management unit 305 of the print server 103, in step S403, transmits a registration response to the printing apparatus 102. The registration response may include the logical printer ID of the logical printer with which the printing apparatus 102 is associated. The registration control unit 303 of the printing apparatus 102 then receives this registration response.

In step S404, the registration control unit 303 of the printing apparatus 102 transmits an information update request to the print server 103, in response to receiving the registration response from the print server 103. The information update request is a request to update information relating to the printing apparatus 102. The information update request includes the logical printer ID included in the registration response transmitted in step S403 and attribute information of the printing apparatus 102 (physical printer). For example, the information update request may include an update request for the job form, printable paper size, and paper type of print jobs that the printing apparatus 102 can receive. Note that the information update request may be transmitted with, for example, an update-output-device-attributes request message defined in IPP. The registration management unit 305 of the print server 103 then receives this information update request.

In step S405, the registration management unit 305 of the print server 103 updates the information of the logical printer, using the logical printer ID and physical printer attributes that are included in the received information update request. More specifically, the registration management unit 305 instructs the recording unit 306 to update the attribute information of the printing apparatus 102, that is, the physical printer, associated with the logical printer recorded in the recording unit 306 of the print server 103.

FIG. 5B illustrates the logical printer information 501 shown in FIG. 5A after the attribute information of an associated printer in part of the logical printer information has been updated by the recording unit 306, in response to such an instruction. The recording unit 306, first, extracts the record 506 (FIG. 5A) of the logical printer information 501 that includes the received logical printer ID. Next, the recording unit 306 updates the values of fields that store the received attribute information of the printing apparatus 102, that is, the physical printer, out of the fields in the record 506. More specifically, if the received attribute information of the physical printer includes, for example, the supported job form of receivable print jobs, the supported paper size that is printable, and the supported paper type, the recording unit 306 executes the following processing. That is, the recording unit 306 updates the values of the fields corresponding to this information (supported job form 508, supported paper size 509, supported paper type 510).

In step S405, the registration management unit 305 of the print server 103 transmits an information update response to the printing apparatus 102. The information update response may be a message indicating that the update processing by the print server 103 was completed successfully. The registration control unit 303 of the printing apparatus 102 then receives this information update response.

In step S406, the registration control unit 301 of the information processing apparatus 101 transmits a logical printer request to the print server 103, in accordance with an instruction from the user of the information processing apparatus 101. The logical printer request is a request to obtain information relating to the logical printer that can be used by the user of the information processing apparatus 101. The logical printer request may include a user ID that uniquely represents the user who gave the instruction. Note that the logical printer request may be transmitted with, for example, a Get-Printer-Attributes Request message defined in IPP. The registration management unit 305 of the print server 103 then receives the logical printer request from the information processing apparatus 101.

In step S407, the registration management unit 305 of the print server 103 extracts a logical printer that can be used by the user who transmitted the logical printer request, in response to receiving the logical printer request from the information processing apparatus 101. For example, if the user ID included in the logical printer request is “U-000002”, the registration management unit 305 refers to the logical printer information 501 in FIG. 5B and extracts the record 507 that includes “U-000002” in the user ID 503. Note that FIG. 5B shows an example of extracting a single logical printer, but a plurality of logical printers may be extracted.

The registration management unit 305 then transmits a logical printer response to the information processing apparatus 101. The logical printer response includes the logical printer ID and printer attributes for each of one or more logical printers that can be used by the user of the information processing apparatus 101. The printer attributes include, for example, information using the supported job form 508, the supported paper size 509, the supported paper type 510, and the like shown in FIG. 5B.

Note that the registration management unit 305 responds with the supported job form in the printer attributes as “compressed”, even if information of some sort is stored in the supported job form 508, for example (example of “outputting that the form of the print job is the predetermined form”). That is, even if the supported job form 508 of the physical printer is only “uncompressed”, as shown in the record 507 of FIG. 5B, the registration management unit 305 responds with the supported job form as “compressed”. As a result of the above, the print server 103 provides a logical printer capable of transmitting print jobs in compressed form from the information processing apparatus 101. The printing control unit 302 of the information processing apparatus 101 then receives this logical printer response. Note that the logical printer response may be transmitted with, for example, a Get-Printer-Attributes Response message defined in IPP.

In step S408, the printing control unit 302 of the information processing apparatus 101 transmits a print request to the print server 103, in accordance with an instruction from the user of the information processing apparatus 101. The print request includes the logical printer ID, the print job, and the print job form. The print request is for requesting the logical printer having the logical printer ID included in the print request to print the print data included in the print request. The print job includes print data and print settings. The print job form includes the compression form of the print job such as “compressed” or “uncompressed”, for example. Also, the print settings may be included in the print request, or may be included in both the print request and the print job. Also, the print request may include the user ID representing the user who gave the instruction, the job name used to display the print job, and the like.

Here, if, in step S407, a response with the supported job form “compressed” is received as a printer attribute of the logical printer, the printing control unit 302 transmits a print request indicating that the print job included in the print request is in “compressed” form. In such a case, the communication efficiency of transmission and reception of print jobs between the information processing apparatus 101 and the print server 103 improves due to the data of the print job being compressed. The printing management unit 307 of the print server 103 then receives such a print request from the information processing apparatus 101. Note that the print request may be transmitted with, for example, a Send-Document Request message defined in IPP.

In step S409, the printing management unit 307 of the print server 103 instructs the conversion determination unit 308 of the print server 103 to determine the conversion method of the print job, in response to receiving the print request from the information processing apparatus 101. The conversion determination unit 308 of the print server 103 determines the conversion method of the print job according to this instruction. The flow of determining the conversion method of a print job will be described in detail later.

Next, the printing management unit 307 of the print server 103 instructs the recording unit 306 to record the print job. The recording unit 306 records print job information to a storage medium as shown in FIG. 5C, for example. In FIG. 5C, print job information 511 illustrates part of the print job information recorded to the storage medium by the recording unit 306 of the print server 103. Each record of the print job information 511 includes attribute information for the print job.

More specifically, the attribute information of a print job includes, for example, a print job ID capable of uniquely identifying the print job, a logical printer ID that uniquely represents the logical printer that processes the print job, and a request date-time. The recording unit 306 stores this information in the respective fields of print job ID 512 (example of “second identification information”), logical printer ID 513, and request date-time 514 in the print job information 511 shown in FIG. 5C.

Also, the print request may include detailed information of the print job such as the file path of the print job recorded as a file and the file form of the print job. The recording unit 306 stores this detailed information in the respective fields of file path 515 and file form 516 shown in FIG. 5C. Also, the print request may include, for example, additional information of the print job such as a user ID that can uniquely identify the user who transmitted the print request and a job name that is used in display of the print job. The recording unit 306 may store this additional information of the print job in the respective fields of requesting user 517 and job name 518 shown in FIG. 5C.

Also, the recording unit 306 stores the conversion method of the print job determined by the conversion determination unit 308 of the print server 103 as attribute information of the print job in the respective fields of conversion timing 519 and conversion form 520. For example, if the conversion determination unit 308 of the print server 103 determines not to convert the print job, “NA” (Not Applicable) is stored in the conversion timing 519 and the conversion form 520. A record 521 in FIG. 5C exemplifies a record in which such field values are stored. Also, for example, if the conversion determination unit 308 of the print server 103 determines to convert the print job to “uncompressed” “at time of print job response”, “at time of print job response” is stored in the conversion timing 519 and “uncompressed” is stored in the conversion form 520. A record 522 exemplifies a record in which such field values are stored.

Returning to the description of the sequence flow in FIG. 4, the printing management unit 307 of the print server 103, in step S409, transmits a print response to the information processing apparatus 101. The print response may be a message indicating that the print request was processed successfully. The printing control unit 302 of the information processing apparatus 101 then receives this print response.

In step S410, the printing control unit 304 of the printing apparatus 102 transmits a print job request to the print server 103. The print job request is a request to obtain a print job to be processed by the printing apparatus 102. The print job request may include a logical printer ID that uniquely represents the logical printer with which the requested printing apparatus 102 is associated. Note that the printing apparatus 102 may transmit the print job request at regular intervals. Also, the printing control unit 304 may be configured to notify the print server 103 of an event to be processed by the printing apparatus 102 in advance, and may transmit the print job request in response to receiving a print event notified by the print server 103. The printing management unit 307 of the print server 103 then receives this print job request.

In step S411, the printing management unit 307 of the print server 103 obtains the print job to be processed by the printing apparatus 102, in response to receiving the print job request from the printing apparatus 102. For example, in the case where the logical printer ID included in the print job request is “LP-000003”, the printing management unit 307 refers to the print job information 511 in FIG. 5C. The printing management unit 307 then extracts a record 522 having the oldest request date-time 514 among the records in which 'LP-000003' is included in the logical printer ID 513.

Next, the printing management unit 307 of the print server 103 instructs the form conversion unit 309 of the print server 103 to convert the print job using the conversion method of the print job recorded in step S409. For example, if the print job obtained in step S411 is the record 522 of the print job information 511 in FIG. 5C, the conversion timing 519 is “at time of print job response” and the conversion form 520 is “uncompressed”. Accordingly, the printing management unit 307 of the print server 103 instructs the form conversion unit 309 to convert the print job to uncompressed, that is, to decompress the print job. Note that, if the conversion timing 519 is not “at time of print job response” or the conversion form 520 is “NA”, the printing management unit 307 of the print server 103 does not instruct the form conversion unit 309 to convert the print job. The form conversion unit 309 executes conversion of the print job, according to an instruction of the printing management unit 307.

The printing management unit 307 of the print server 103 then transmits a print job response to the printing apparatus 102. The print job response includes the print job. Here, if the form conversion unit 309 has converted the print job, the print job response includes this converted print job. Note that the print job response may be a Fetch-Job Response in IPP.

The printing control unit 304 of the printing apparatus 102 receives the print job response from the print server 103. The printing control unit 304 then starts printing using the print data and print settings included in the print job of the print job response, in response to receiving the print job response. The processing then ends.

### Example of Processing for Determining Conversion Method of Print Job

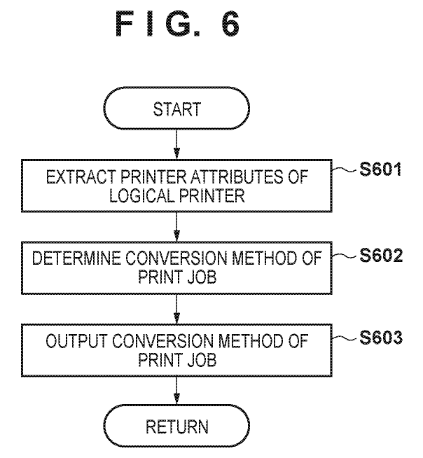

Processing for determining the conversion method of the print job by the conversion determination unit 308 of the print server 103 in step S409 will be described in detail using FIG. 6. Note that this flow is realized by the CPU 201 of the print server 103 loading a program stored in the ROM 203 into the working area of the RAM 202 and executing the loaded program, and the constituent units and the like being controlled through execution of the program.

In step S601, the conversion determination unit 308 of the print server 103 obtains printer attributes of the logical printer. More specifically, the conversion determination unit 308 receives the logical printer ID from the printing management unit 307 of the print server 103. Note that this logical printer ID is included in the print request received from the information processing apparatus 101 in step S408. The conversion determination unit 308 then extracts records corresponding to the logical printer ID from a table such as is shown in FIG. 5B. For example, if “LP-000003” is received as the logical printer ID, the conversion determination unit 308 scans the logical printer information 501 shown in FIG. 5B and extracts the record 507.

Next, the conversion determination unit 308 extracts the attribute information of the printer associated with the logical printer from the extracted record. Here, it is assumed that the conversion determination unit 308 extracts the field value stored in the supported job form 508, when the record 507 of the logical printer information 501 is extracted.

In step S602, the conversion determination unit 308 determines the conversion method of the print job. More specifically, the conversion determination unit 308 determines the conversion timing and the conversion form of the job, using the supported job form extracted in step S601. For example, if “uncompressed” is extracted as the supported job form, the conversion determination unit 308 determines the conversion timing as “at time of print job response” and the conversion form as “uncompressed”. In such a case, the printer associated with the logical printer will not support the job form “compressed”. Accordingly, such a determination indicates that, in step S411 in FIG. 4, the form conversion unit 309 converts the print job to uncompressed, before sending the print job response to the printing apparatus 102.

Note that if “compressed” is extracted as the supported job form, for example, the conversion determination unit 308 determines the conversion timing and the conversion form to be “NA”. That is, such a determination indicates that the printer associated with the logical printer will support the job form “compressed”, and thus there is no need to convert the print job.

In step S603, the conversion determination unit 308 outputs the conversion method of the print job determined in step S602. The conversion method of the print job to be output includes the conversion timing and the conversion form. The processing returns to step S409 in FIG. 4.

### Variation of Processing for Determining Conversion Method of Print Job

In the description of the aforementioned step S602, an example of determining the conversion method of a print job depending on attributes of a printer associated with a logical printer is described. Alternatively, the conversion determination unit 308 of the print server 103 may determine the conversion method using information relating to a print job to be processed by a physical printer. Note that, in such a case, it is assumed that the printing apparatus 102 is capable of converting a print job from “compressed” form to “uncompressed” form.

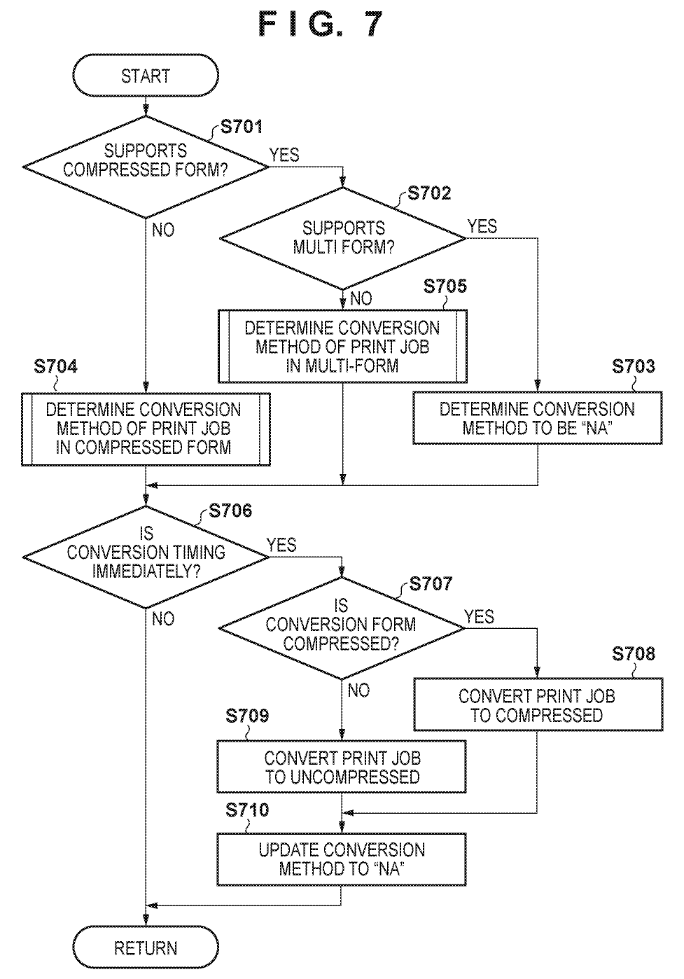

Processing for determining the conversion method of a print job using attributes of the print job as an alternative to step S602 will be described in detail using FIG. 7. Note that this flow is realized by the CPU 201 of the print server 103 loading a program stored in the ROM 203 into the working area of the RAM 202 and executing the loaded program, and the constituent units and the like being controlled through execution of the program.

In step S701, the conversion determination unit 308 of the print server 103 determines whether the printer supports print jobs in “compressed” form, with reference to the supported job form extracted in step S601. For example, if the values of the states stored in the supported job form 508 extracted in step S601 include “compressed”, the conversion determination unit 308 determines that the printer supports print jobs in “compressed” form. The processing proceeds to step S702 if the conversion determination unit 308 determines that the printer supports print jobs in “compressed” form, and the processing proceeds to step S704 if that is not the case.

In step S702, the conversion determination unit 308 determines whether the printer supports print jobs in a form in which “one print job includes a plurality of jobs” (hereinafter also referred to as “multi” form), with reference to the supported job form extracted in step S601. For example, if the values stored in the supported job form extracted in step S601 include “multi”, the conversion determination unit 308 determines that the printer supports print jobs in “multi” form. The processing proceeds to step S703 if the conversion determination unit 308 determines that the printer supports print jobs in “multi” form, and the processing proceeds to step S705 if that is not the case.

In step S703, the conversion determination unit 308 determines the conversion method of the print job to be “NA”. That is, the conversion determination unit 308 determines the conversion timing and the conversion form to be “NA”. The processing then proceeds to step S706.

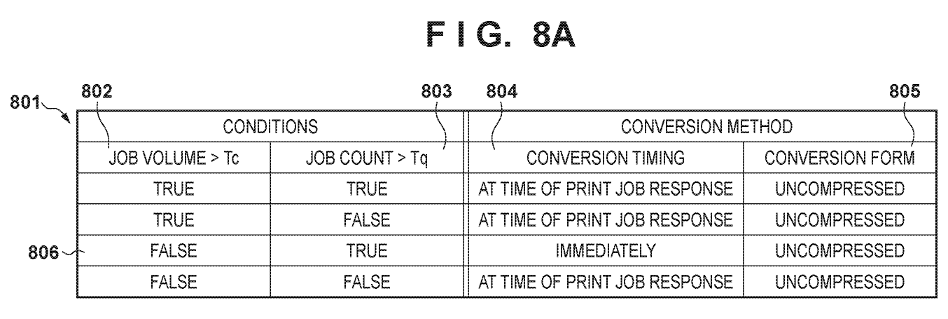

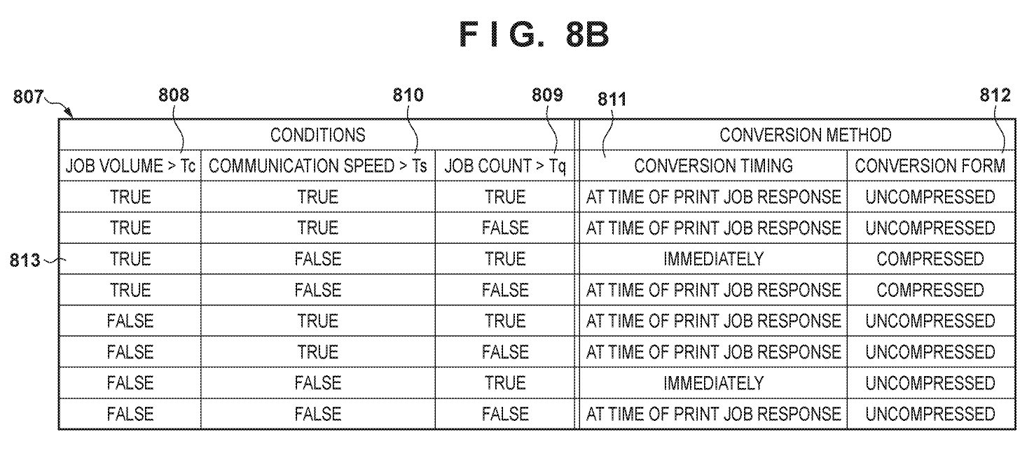

In step S704, the conversion determination unit 308 determines the conversion method of the print job in compressed form. Specifically, the conversion determination unit 308 determines the conversion method using a compressed form job conversion table 801 shown in FIG. 8A. The compressed form job conversion table 801 is table information that stores conversion methods corresponding to conditions. The conditions include information on whether the job volume exceeds a job volume threshold Tc. This information is stored in a job volume condition 802 column. Also, the conditions include information on whether the job count exceeds a job count threshold Tq. This information is stored in a job count condition 803 column. Also, the conversion method includes the conversion timing and the conversion form. The conversion timing is stored in a conversion timing 811 column. Also, the conversion form is stored in a conversion form 812 column.

More specifically, the conversion determination unit 308, first, calculates the job volume and the job count. The job volume is calculated as the file size of the print job recorded as a file. The job count is calculated as the number of print jobs that include the logical printer ID received from the printing management unit 307 of the print server 103 as an attribute, with reference to the print job information 511 in FIG. 5C.

Next, the conversion determination unit 308 determines whether the calculated job volume is greater than the job volume threshold Tc. The conversion determination unit 308 then sets the determination result as true if it is determined that the job volume is greater than the job volume threshold Tc, and sets the determination result as false if that is not the case. Also, the conversion determination unit 308 determines whether the calculated print job count is greater than the job count threshold Tq. The conversion determination unit 308 then sets the determination result as true if it is determined that the print job count is greater than the job count threshold Tq, and sets the determination result as false if that is not the case.

Next, the conversion determination unit 308 selects a record that includes field values that match the true/false values of the job volume condition 802 and the job count condition 803 from the table shown in FIG. 8A. The conversion determination unit 308 then determines the field values stored in a conversion timing 804 and a conversion form 805 included in the selected record as the conversion method of the print job. For example, if the job volume is less than the job volume threshold Tc and the job count is greater than the job count threshold Tq, the conversion determination unit 308 selects a record 806 in the compressed form job conversion table 801. The conversion determination unit 308 then determines the conversion timing to be “immediately” and the conversion form to be “uncompressed” as the conversion method. The processing then proceeds to step S706.

In step S705, the conversion determination unit 308 determines the conversion method of a print job in multi-form. Specifically, the conversion determination unit 308 determines the conversion method using a multi-form job conversion table 807 shown in FIG. 8B. The conversion determination unit 308, first, calculates the job volume, the job count, and the communication speed. Since the calculation method of job volume and job count is similar to step S704, description will be omitted. With regard to communication speed, the recording unit 306 records the communication speed between the print server 103 and the physical printer associated with the logical printer ID received by from the printing management unit 307 of the print server 103 in advance. The conversion determination unit 308 then refers to this recorded communication speed. For example, in step S411, the CPU 201 of the print server 103 measures the communication speed when transmitting a print job response. The recording unit 306 may then record and update the communication speed as an attribute of the logical printer information 501 in FIG. 5B.

Next, the conversion determination unit 308 obtains, for the calculated job volume and job count, true/false values similarly to the processing in step S704. Also, the conversion determination unit 308 determines whether the recorded communication speed exceeds a communication speed threshold Ts. The conversion determination unit 308 then sets the determination result as true if it is determined that the communication speed exceeds the communication speed threshold Ts, and sets the determination result as false if that is not the case.

The conversion determination unit 308 then selects a record that includes field values that match the true/false values of a job volume condition 808, a job count condition 809, and a communication speed condition 810 from the multi-form job conversion table 807 shown in FIG. 8B. The conversion determination unit 308 then determines the field values stored in the conversion timing 811 and the conversion form 812 included in the selected record as the conversion method of the print job. For example, if the job volume is greater than the job volume threshold Tc, the job count is greater than the job count threshold Tq, and the communication speed is less than the communication speed threshold Ts, the conversion determination unit 308 selects a record 813 in the multi-form job conversion table 807. The conversion determination unit 308 then determines the conversion timing to be “immediately” and the conversion form to be “compressed” as the conversion method. The processing then proceeds to step S706.

In step S706, the conversion determination unit 308 determines whether the conversion timing is “immediately”. The processing proceeds to step S707 if the conversion determination unit 308 determines that the conversion timing is “immediately”, and the processing proceeds to step S603 of the flowchart in FIG. 6 if that is not the case.

In step S707, the conversion determination unit 308 of the print server 103 determines whether the conversion form is “compressed”. The processing proceeds to step S708 if the conversion determination unit 308 determines that the conversion form is “compressed”, and the processing proceeds to step S709 if that is not the case.

In step S708, the conversion determination unit 308 converts the print job to compressed form. Here, if the print job is a print job in “multi” form, the conversion determination unit 308 separates the print job to generate a plurality of print jobs. The conversion determination unit 308 then compresses each of the separate print jobs. The processing then proceeds to step S710.

In step S709, the conversion determination unit 308 of the print server 103 converts the print job to uncompressed form. That is, the conversion determination unit 308 decompresses the print job. Here, if the print job is a print job in “multi” form, the conversion determination unit 308 separates the print job to generate a plurality of print jobs. The processing then proceeds to step S710.

In step S710, the conversion determination unit 308 updates the conversion method of the print job to “NA”. That is, in step S708 or S709, the conversion determination unit 308 updates the conversion timing and the conversion form to “NA”, in order to show that the print job is not to subsequently be converted, as a result of the print job being immediately converted. The processing then proceeds to step S603 in the flowchart of FIG. 6.

Note that in step S708 or S709, if the print job is separated into a plurality of print jobs, the conversion method of the plurality of print jobs may be determined for each of the separate print jobs. If a plurality of conversion methods are determined, the conversion determination unit 308, in step S603, outputs the plurality of print job conversion methods to the printing management unit 307 of the print server 103. The printing management unit 307 of the print server 103 may instruct the recording unit 306 of the print server 103 to record each of these print job conversion methods.

### One Aspect of Operation and Effect

According to the information processing system 10 as described above, it becomes possible to transmit and receive print jobs in compressed form between the information processing apparatus 101 and the print server 103. Also, it becomes possible to efficiently store print jobs in compressed form in the print server 103. That is, the communication amount of print data between the information processing apparatus 101 and the print server 103 and the data amount of print data recorded in the print server 103 can be reduced. Therefore, it becomes possible to streamline the communication amount or storage amount of print jobs.

Note that the first embodiment shows a conversion example related to whether or not the print job is compressed, in order to streamline the communication amount or storage amount of print data, but the first embodiment may be applied to other conversion examples. For example, the first embodiment may be applied to a conversion example relating to the compression format form (e.g., zip, gzip, etc.) or job configuration (e.g., whether one print job includes a plurality of jobs). Also, the first embodiment may be applied to a conversion example relating to the form of print data included in print jobs, such as compressed PDF (Portable Document Format) or JPEG. That is, the conversion example of print job form is not limited to the example of the above embodiment as long as the communication amount of print data between the information processing apparatus 101 and the print server 103 and the data amount of print data stored in the print server 103 are reduced.

Also, the first embodiment shows an example of converting a print job at the time of transmitting a response to a print job request from the printing apparatus 102, but the timing of conversion is not limited thereto. For example, the print job may be converted at the time of transmitting a response to a print request from the information processing apparatus 101 (steps S408 and S409). That is, the information processing apparatus 101 makes a request to obtain a print job transmitted in advance to the print server 103, in order to confirm the details of the print job in response to an instruction from the user. Here, depending on the content of the print job request, the print job may be decompressed and extracted. In view thereof, the print server 103, having received the print job request, may convert the print job to uncompressed form similarly to the processing described in step S411, and thereafter transmit the print job response.

### Second Embodiment

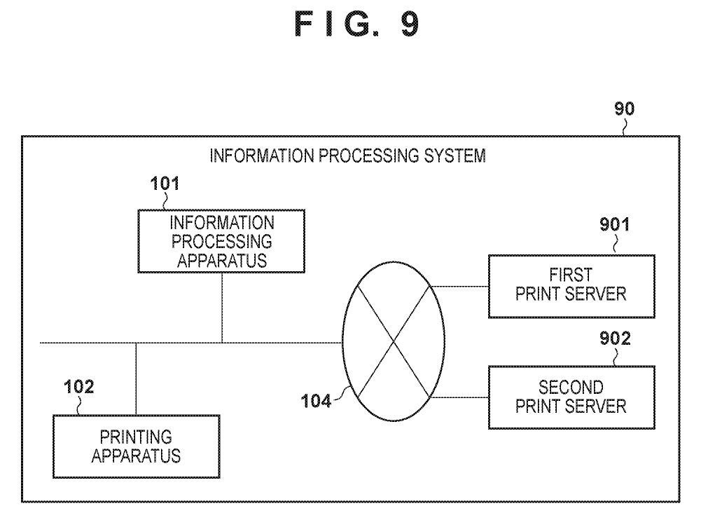

The first embodiment shows an example in which there is a single print server 103, whereas the second embodiment illustrates an embodiment in which a plurality of print servers are provided. An example configuration of an information processing system according to the second embodiment will be described using FIG. 9. In FIG. 9, the information processing system 90 includes a first print server 901 (example of “first information processing apparatus”) and a second print server 902 (example of “second information processing apparatus”), in addition to the information processing apparatus 101 and the printing apparatus 102. The first print server 901 and the second print server 902 may cooperate with a server that provides a Universal Print service to provide a cloud print service.

Note that the computer 200 illustrated in FIG. 2A in the first embodiment may be used as the first print server 901 and the second print server 902 according to the second embodiment. Since the hardware configurations of the other apparatuses are similar to the aforementioned first embodiment, detailed description thereof is omitted.

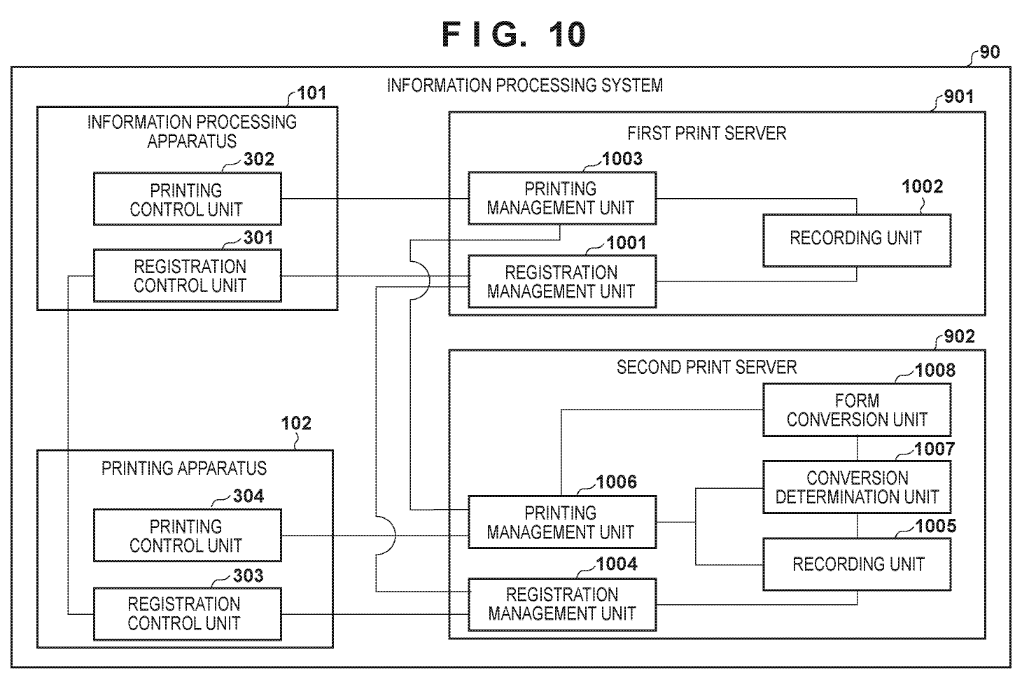

The functional blocks of the information processing system 90 according to the second embodiment will be described using FIG. 10. The functions of the information processing system 90 include the functions of the first print server 901 and the second print server 902, instead of the print server 103 of the information processing system 10 according to the first embodiment. The functional units of FIG. 10 may be realized by the CPU 201 executing programs read out to the RAM 202 of the computer 200. Also, these functional units may be realized by the CPU 231 executing programs read out to the RAM 232 of the printer 230. Alternatively, some or all of the functional units in FIG. 10 may be realized by a dedicated processing circuit such as an application-specific integrated circuit (ASIC). Note that the CPU 201 of the first print server 901 is an example of a “first control unit”, and the CPU 201 of the second print server 902 is an example of a “second control unit”.

Since the registration control unit 301 and the printing control unit 302 of the information processing apparatus 101 are similar to the registration control unit 301 and the printing control unit 302 of the information processing apparatus 101 according to the first embodiment, detailed description thereof is omitted. Note that the target of registration and print processing by the information processing apparatus 101 has changed to the first print server 901.

Since the registration control unit 303 and the printing control unit 304 of the printing apparatus 102 are similar to the registration control unit 303 and the printing control unit 304 of the printing apparatus 102 according to the first embodiment, detailed description thereof is omitted. Note that the target of registration and print processing by the printing apparatus 102 has changed to the second print server 902.

The first print server 901 includes a registration management unit 1001, a recording unit 1002, and a printing management unit 1003. The registration management unit 1001 performs processing for registering a logical printer. For example, the registration management unit 1001 generates a logical printer in association with a printer managed by the second print server 902, in response to a registration request from the second print server 902, and stores the generated logical printer in the recording unit 1002 of the first print server 901. The logical printer registered in the recording unit 1002 of the first print server 901 is recognized as a printer by the information processing apparatus 101. Note that the logical printer may be associated with only one printer that is managed by the second print server 902. The printer managed by the second print server 902 may be associated with only one logical printer or may be associated with a plurality of logical printers.

The recording unit 1002 performs processing such as storing information in the RAM 202 or the storage device 204 in accordance with instructions from other functional units and reading out information from the RAM 202 or the storage device 204. The printing management unit 1003 performs processing related to print jobs for a logical printer. For example, the printing management unit 1003 receives a print job for a logical printer from the information processing apparatus 101. The printing management unit 1003 then uses the received print job to transmit a print job to the logical printer managed by the second print server 902 associated with the logical printer. Also, the printing management unit 1003 may control events related to the print job. Events related to the print job may include reception of a print job and the like, for example. Also, the printing management unit 1003 may return an event related to the printer, in response to receiving an event request from the printer managed by the second print server 902.

The second print server 902 includes a registration management unit 1004, a recording unit 1005, a printing management unit 1006, a conversion determination unit 1007, and a form conversion unit 1008. The registration management unit 1004 performs processing for registering a logical printer. For example, the registration management unit 1004 generates a logical printer in association with a physical printer, in response to a registration request from the printing apparatus 102, and stores the generated logical printer in the recording unit 1005 of the second print server 902. Also, the registration management unit 1004 requests the first print server 901 to register the logical printer associated with the printer managed by the second print server 902. The logical printer instructed to be stored in the recording unit 1005 of the second print server 902 is recognized as a printer by the first print server 901. Note that the physical printer associated with the logical printer may be a physical printer that performs printing in accordance with print jobs input to the logical printer. Also, the logical printer may be associated with only one physical printer. Also, a physical printer may be associated with only one logical printer, or may be associated with a plurality of logical printers.

The recording unit 1005 performs processing such as storing information in the RAM 202 or the storage device 204 and reading out information from the RAM 202 or the storage device 204, in accordance with instructions from other functional units. The printing management unit 1006 performs processing related to print jobs for a logical printer. For example, the printing management unit 1006 receives a print job for a logical printer from the first print server 901, and uses the received print job to transmit a print job to the physical printer associated with the logical printer. Also, the printing management unit 1006 may control events related to the print job. Events related to a print job may include reception of a print job and the like, for example. Also, the printing management unit 1006 may return an event related to the printer, in response to receiving an event request from the physical printer.

The conversion determination unit 1007 determines the conversion method of the print job received from the first print server 901, when instructed by the printing management unit 1006. For example, assume that the form of the print job received from the first print server 901 does not match the form of print jobs processable by the physical printer associated with a designated logical printer. In such cases, the conversion determination unit 1007 determines the method of converting the print job to a form processable by the physical printer. The printing management unit 1006 instructs the recording unit 1005 to record the determined method of converting the print job.

The form conversion unit 1008 converts the form of the print job received from the first print server 901, when instructed by the printing management unit 1006. For example, if the print job is compressed, the form conversion unit 1008 converts the compressed print job to a print job in uncompressed form, by executing decompression processing. Note that the form conversion unit 1008 may include, as form conversion of a print job, not only conversion to compressed/uncompressed but also conversion of the compression format form (e.g., zip, gzip, etc.) or the job configuration (e.g., whether one print job includes a plurality of jobs, etc.). The converted print job is, for example, transmitted to the printing apparatus 102 by the printing management unit 1006 of the second print server 902. The print job is then executed in the printing apparatus 102.

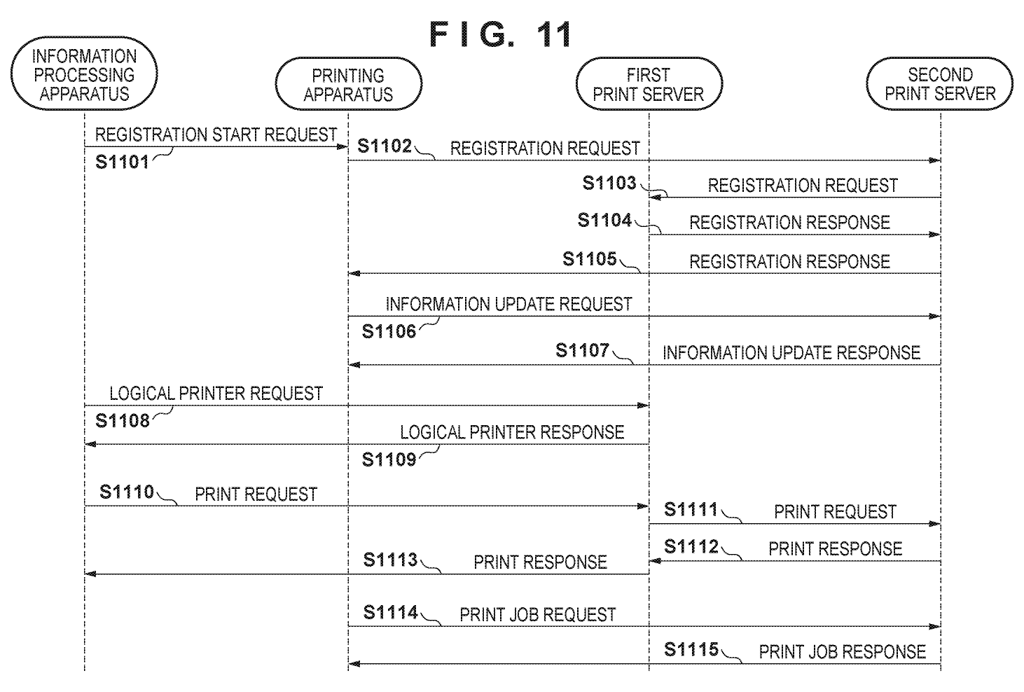

The processing of cloud printing executed by the information processing system 90 according to the second embodiment will be described using FIG. 11. Note that this sequence flow is realized by, in each apparatus, the CPU loading a program stored in the ROM into the working area of the RAM and executing the loaded program, and the constituent units and the like being controlled through execution of the program.

Since step S1101 is similar to step S401 according to the first embodiment, detailed description thereof is omitted. In step S1102, the registration control unit 303 of the printing apparatus 102 transmits a registration request to the second print server 902, in response to receiving a registration start request from the information processing apparatus 101. The registration request is a request to register the printing apparatus 102 in the second print server 902. This request may include the user ID included in the registration start request received from the information processing apparatus 101. The second print server 902 then receives the registration request.

In step S1103, the registration management unit 1004 of the second print server 902 generates a new logical printer, in response to receiving the registration start request from the printing apparatus 102. Also, the registration management unit 1004 instructs the recording unit 1005 of the second print server 902 to record the generated logical printer in association with the printing apparatus 102, that is, a physical printer. Since the logical printer information that is recorded is the same as the information shown in FIG. 5A of the first embodiment, detailed description thereof is omitted.

Also, the registration management unit 1004 transmits a registration request to the first print server 901. The registration request to the first print server 901 is a request to register the generated logical printer in the first print server 901. The registration request to the first print server 901 may include information of the printer associated with the logical printer. Information of the printer is, for example, the logical printer ID of the logical printer generated by the second print server 902, printer attributes and the like. The printer attributes include the supported job form being “compressed”. That is, the registration management unit 1004 requests the first print server 901 to generate a logical printer that can transmit a print job in compressed form from the information processing apparatus 101. The registration management unit 1001 of the first print server 901 then receives this request.

In step S1104, the registration management unit 1001 of the first print server 901 generates a new logical printer, in response to receiving the registration request from the second print server 902. Also, the registration management unit 1001 instructs the recording unit 1002 to record the newly generated logical printer in association with the logical printer managed by the second print server 902. Since the logical printer information that is recorded is the same as the information shown in FIG. 5A in the first embodiment, detailed description thereof is omitted.

Note that, if the registration request received from the second print server 902 includes the logical printer ID of the logical printer managed by the second print server 902 and the attribute information of the logical printer, the registration management unit 1001 of the first print server 901 may execute the following processing. That is, the registration management unit 1001 may instruct the recording unit 1002 to record this information. That is, the recording unit 1002 may store the logical printer ID of the logical printer managed by the second print server 902 and the attribute information of the logical printer in the respective fields of associated printer ID and printer attributes such as is shown in FIG. 5B.

The registration management unit 1001 of the first print server 901 then transmits a registration response to the second print server 902. The registration response may include the logical printer ID of the logical printer managed by the first print server 901. The registration management unit 1004 of the second print server 902 then receives this registration response.

In step S1105, the registration management unit 1004 of the second print server 902 transmits a registration response to the printing apparatus 102, in response to receiving the registration response from the first print server 901. The registration response may include the logical printer ID of the logical printer managed by the second print server 902.

Since steps S1106 and S1107 are similar to steps S404 and S405 in the first embodiment, detailed description thereof is omitted. Note that, in step S1106, the second print server 902 may transmit the attribute information of the physical printer received from the printing apparatus 102 to the first print server 901. The recording unit 1002 of the first print server 901 may then update the printer attributes to the received attribute information.

Since steps S1108 and S1109 are similar to steps S406 and S407 in the first embodiment, detailed description thereof is omitted. Note that, as described in step S1103, if the supported job form of the printer attributes includes “compressed”, in step S1109, the registration management unit 1001 of the first print server 901 transmits a response indicating that the supported job form is “compressed” to the information processing apparatus 101. That is, the first print server 901 provides a logical printer that can transmit print jobs in compressed form from the information processing apparatus 101.

In step S1110, the printing control unit 302 of the information processing apparatus 101 transmits a print request to the first print server 901, in accordance with an instruction from the user of the information processing apparatus 101. Since the print request is similar to step S408 in the first embodiment, detailed description thereof is omitted. Note that if the supported job form of the logical printer is “compressed” in step S1109, the print job included in the print request is transmitted in “compressed” form. That is, the communication efficiency of transmission and reception of print jobs between the information processing apparatus 101 and the first print server 901 improves due to compression.

In step S1111, the first print server 901 transmits the print request received from the information processing apparatus 101 to the second print server 902. Here, the registration management unit 1004 of the second print server 902 obtains, from the print request, the logical printer that is indicated by the logical printer ID included in the print request, which is the logical printer managed by the registration management unit 1004. The registration management unit 1004 then specifies a logical printer associated with the obtained logical printer. The printing management unit 1006 of the second print server 902 then transmits the print job to the specified logical printer (described in detail later). Note that, if the registration management unit 1001 of the first print server 901 responds with the supported job form of the logical printer as “compressed” in step S1109, the print job included in the print request is in “compressed” form, and thus the print job is directly transmitted as is in “compressed” form. That is, the communication efficiency of the transmission and reception of print jobs between the first print server 901 and the second print server 902 improves due to compression.

Since step S1112 is similar to step S409 described in the first embodiment, detailed description thereof is omitted. Note that the conversion determination unit 1007 of the second print server 902 determines the conversion method of the print job, using the logical printer ID and the print job included in the print request received in step S1111. Since the flow of the determination processing of the conversion method is similar to FIGS. 6 and 7 of the first embodiment, detailed description thereof is omitted.

In step S1113, the printing management unit 1003 of the first print server 901 transmits the print response received from the second print server 902 to the information processing apparatus 101. The printing control unit 302 of the information processing apparatus 101 then receives this print response.

Since steps S1114 and S1115 are similar to steps S410 and S411 described in the first embodiment, detailed description thereof is omitted. As a result of the above, the printing apparatus 102 starts printing, using the print data and print settings included in the print job received via the first print server 901 and the second print server 902. The processing then ends.

### One Aspect of Operation and Effect

According to the second embodiment, it becomes possible to transmit and receive print jobs in compressed form between the information processing apparatus 101 and the first print server 901 and between the first print server 901 and the second print server 902. Accordingly, the communication amount of print data can be reduced. Also, the data amount that is stored can be reduced, by storing print jobs in compressed form in the first print server 901 and the second print server 902. Therefore, it becomes possible to streamline the communication amount or storage amount of print jobs.

Note that the second embodiment shows an example in which two print servers mediate, but the number of print servers is not limited to two. The information processing system may be mediated by three or more print servers, and the conversion determination unit and the form conversion unit need only be provided in at least one of those print servers.

### Other Variations

Although embodiment examples have been described in detail above, the present disclosure can, for example, adopt a mode as a system, apparatus, method, program, or recording medium (storage medium). Specifically, the present disclosure may be applied to a system constituted by a plurality of devices (e.g., host computer, interface device, reception apparatus, web application, etc.), or may be applied to an apparatus constituted by one device.

The object of the present disclosure is, needless to say, achieved by the following. That is, a recording medium (or storage medium) on which program code (computer program) of software that realizes the functions of the aforementioned embodiments is supplied to a system or apparatus. This storage medium is, needless to say, a computer-readable storage medium. A computer (or CPU or MPU) of the system or apparatus reads out and executes program code stored in the recording medium. In this case, the program code read out from the recording medium itself realizes the functions of the aforementioned embodiments, and the recording medium on which that program code is recorded constitutes the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-045620, filed March 19, 2025, which is hereby incorporated by reference herein in its entirety.

What is claimed is:

1. An information processing apparatus configured to cooperate with a server that provides a cloud print service, the information processing apparatus comprising
one or more memory devices that store a set of instructions; and
one or more processors that execute the set of instructions to:
output a predetermined form for a print job that streamlines a communication amount or a storage amount to another information processing apparatus that generates the print job;
obtain the print job in the predetermined form from the other information processing apparatus;
determine a conversion method for converting the predetermined form of the obtained print job into a form processable by an image forming apparatus; and
convert a form of the print job using the conversion method.

2. The information processing apparatus according to claim 1, wherein
the predetermined form includes at least one of a compressed form of the print job, a compression format form of the print job, a form in which one print job includes a plurality of print jobs, and a compressed form of print data included in the print job.

3. The information processing apparatus according to claim 1, wherein
the conversion method includes whether to convert the form of the print job and a conversion timing.

4. The information processing apparatus according to claim 3, wherein
the conversion timing includes a timing of a response to a request to obtain the print job from the image forming apparatus or a timing of a response to a print request from the other information processing apparatus.

5. The information processing apparatus according to claim 1, wherein
determining the conversion method includes
determining whether the image forming apparatus is capable of processing the predetermined form; and
determining a conversion method of the form of the print job according to a determination result.

6. The information processing apparatus according to claim 5, wherein
the one or more processors further execute instructions in the one or more memory devices to:
store first identification information identifying the image forming apparatus and the form of the print job processable by the image forming apparatus in association with each other as first table information, and wherein
determining the conversion method includes determining the conversion method using the first table information.

7. The information processing apparatus according to claim 1, wherein
determining the conversion method includes determining the conversion method using information of the print job including at least a print job volume and a print job count indicating a total number of the print job.

8. The information processing apparatus according to claim 7, wherein
the information of the print job further includes a communication speed between the image forming apparatus and the information processing apparatus.

9. The information processing apparatus according to claim 7, wherein
determining the conversion method using the information of the print job includes, in response to a print request from the other information processing apparatus
determining whether the image forming apparatus is capable of processing a compressed form of the print job,
in a case where it is determined that the image forming apparatus is capable of processing the compressed form of the print job,
determining whether the image forming apparatus is capable of processing a form in which one print job includes a plurality of print jobs,
in a case where it is determined that the image forming apparatus is capable of processing the form in which one print job includes a plurality of print jobs, determining not to convert the print job,
in a case where it is not determined that the image forming apparatus is capable of processing the form in which one print job includes a plurality of print jobs, determining a conversion method of the form of the print job including the plurality of print jobs, and
in a case where it is not determined that the image forming apparatus is capable of processing the compressed form of the print job, determining a conversion method of the print job in the compressed form.

10. The information processing apparatus according to claim 7, wherein
the one or more processors further execute instructions in the one or more memory devices to:
store the print job volume, the print job count, and the conversion method in association with each other as second table information;
store the print job volume, a communication speed between the information processing apparatus and the image forming apparatus, the print job count, and the conversion method in association with each other as third table information; and
determine the conversion method using the second table information or the third table information.

11. The information processing apparatus according to claim 9, wherein
the one or more processors further execute instructions in the one or more memory devices to:
determine whether the conversion method includes converting the print job at a timing of a response to a print request from the other information processing apparatus;
in a case where it is determined that the conversion method includes converting the print job at the timing of the response to the print request from the other information processing apparatus, convert the form of the print job according to the determined conversion method; and
determine not to convert the print job.

12. An information processing system configured to cooperate with a server that provides a cloud print service, the information processing system comprising
a first information processing apparatus; and
a second information processing apparatus, wherein
the first information processing apparatus comprises:
one or more memory devices that store a set of instructions; and
one or more processors that execute the set of instructions to:
output a predetermined form for a print job that streamlines a communication amount or a storage amount to a third information processing apparatus that generates the print job;
obtain the print job in the predetermined form from the third information processing apparatus; and
output the print job to the second information processing apparatus, and
the second information processing apparatus comprises:
one or more memory devices that store a set of instructions; and
one or more processors that execute the set of instructions to:
obtain the print job from the first information processing apparatus;
determine a conversion method for converting the predetermined form of the obtained print job into a form processable by an image forming apparatus; and
convert a form of the print job using the conversion method.

13. The information processing system according to claim 12, wherein
the predetermined form includes at least one of a compressed form of the print job, a compression format form of the print job, a form in which one print job includes a plurality of print jobs, and a compressed form of print data included in the print job.

14. The information processing system according to claim 12, wherein
the conversion method includes whether to convert the form of the print job and a conversion timing.

15. The information processing system according to claim 14, wherein
the conversion timing includes a timing of a response to a request to obtain the print job from the image forming apparatus or a timing of a response to a print request from the third information processing apparatus.

16. The information processing system according to claim 12, wherein
in the second information processing apparatus, determining the conversion method includes
determining whether the image forming apparatus is capable of processing the predetermined form; and
determining a conversion method of the form of the print job according to a determination result.

17. The information processing system according to claim 16, wherein
the one or more processors further execute instructions in the one or more memory devices in the second information processing apparatus to:
store first identification information identifying the image forming apparatus and the form of the print job processable by the image forming apparatus in association with each other as first table information, and wherein
in the second information processing apparatus, determining the conversion method includes determining the conversion method using the first table information.

18. The information processing system according to claim 12, wherein
in the second information processing apparatus, determining the conversion method includes determining the conversion method using information of the print job including at least a print job volume and a print job count indicating a total number of print jobs.

19. A control method of an information processing apparatus configured to cooperate with a server that provides a cloud print service, the control method comprising:
outputting a predetermined form for a print job that streamlines a communication amount or a storage amount to another information processing apparatus that generates the print job;
obtaining the print job in the predetermined form from the other information processing apparatus;
determining a conversion method for converting the predetermined form of the obtained print job into a form processable by an image forming apparatus; and
converting a form of the print job using the conversion method.

20. A non-transitory computer-readable storage medium storing a program for causing a computer to execute a control method of an information processing apparatus configured to cooperate with a server that provides a cloud print service, the control method comprising:
outputting a predetermined form for a print job that streamlines a communication amount or a storage amount to another information processing apparatus that generates the print job;
obtaining the print job in the predetermined form from the other information processing apparatus;
determining a conversion method for converting the predetermined form of the obtained print job into a form processable by an image forming apparatus; and
converting a form of the print job using the conversion method.
